(19) United States
(12) Patent Application Publication
(10) Pub. No.: US 2004/0150913 A1
(43) Pub. Date: Aug. 5, 2004

(54) Disk apparatus and head suspension apparatus

(75) Inventors: Kazuhiro Yoshida, Ome-shi (JP); Jun Ito, Ome-shi (JP); Yasutaka Sasaki, Tachikawa-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/753,444

(22) Filed: Jan. 9, 2004

(30) Foreign Application Priority Data
Jan. 31, 2003 (JP) 2003-025293

(51) Int. Cl. G11B 5/60

(52) U.S. Cl. 360/235.5

(57) ABSTRACT

A head of a disk apparatus comprises a slider including a disk-facing surface positioned to face the surface of a recording medium and configured to fly by an air stream generated by the rotation of the recording medium in the clearance between the surface of the recording medium and the disk-facing surface. The disk-facing surface of the slider is sized not larger than 0.935 (mm)×0.77 (mm), and the head load L (mN) and the lowest linear velocity A (m/s) of the recording medium within the disk apparatus have the following relationship:

L≧2.74×A+2.7.

### CROSS-REFERENCE TO RELATED APPLICATIONS

This application is based upon and claims the benefit of priority from the prior Japanese Patent Application No. 2003-025293, filed Jan. 31, 2003, the entire contents of which are incorporated herein by reference.

### BACKGROUND OF THE INVENTION

1. Field of the Invention

The present invention relates to a disk apparatus, such as a magnetic disk apparatus, and a head suspension assembly used in the disk apparatus.

2. Description of the Related Art

A disk apparatus, e.g., a magnetic disk apparatus, comprises a magnetic disk arranged within a case, a spindle motor supporting and rotating the magnetic disk, a magnetic head for reading/writing information in and out of a magnetic disk, and a carriage assembly supporting the magnetic head to be movable relative to the magnetic disk. The carriage assembly includes an arm that is rotatably supported, and a suspension extending from the arm. The magnetic head is mounted on the extending end of the suspension. The magnetic head comprises a slider mounted on the suspension and a head portion provided at the slider. The head portion includes a reproducing element for the reading operation and a recording element for the writing operation.

The slider includes a disk-facing surface positioned to face the recording surface of the magnetic disk. A prescribed head load directed toward the magnetic recording layer of the magnetic disk is applied to the slider by the suspension. During operation of the magnetic disk apparatus, an air stream is generated between the rotating magnetic disk and the slider, and a force causing the slider to fly from the recording surface of the magnetic disk is exerted on the disk-facing surface of the slider by the principle of the air fluid lubrication. By allowing the flying force to be balanced with the head load, the slider is kept flying with a prescribed flying height defined between the recording surface of the magnetic disk and the slider.

The flying amount of the slider is required to be substantially the same at any radial position of the magnetic disk. It should be noted that the rotational speed of the magnetic disk is constant and, thus, the linear velocity of the magnetic disk under the slider differs depending on the radial position of the slider. Since the position of the magnetic head is determined by the rotary carriage assembly, the skew angle (i.e., the angle defined between the flowing direction and the center line of the slider) also differs depending on the radial position of the slider.

In the design of the slider, it is necessary to suppress the change in the flying amount of the slider depending on the radial position of the magnetic disk by utilizing appropriately the two parameters noted above, which are changed depending on the radial position of the magnetic disk.

Where the change in the environment of use is taken into account, the disk apparatus is required to perform its operation smoothly even under the environment of a reduced pressure in heights. Where the magnetic head is constructed in view of only the balance between the positive pressure applied to the disk-facing surface of the slider because of the air fluid lubrication and the head load, the slider is balanced at the position where the flying amount is lowered or is brought into contact with the surface of the magnetic disk because the positive pressure generated by the air fluid lubrication is lowered under a reduced pressure environment.

Disclosed in, for example, Japanese Patent Disclosure (Kokai) No. 2001-283549 is a disk apparatus having a negative pressure cavity formed in the vicinity of the center of the disk-facing surface of the slider. The negative pressure cavity, which is intended to prevent the loss of the flying amount of the slider noted above, is defined by a groove surrounded by a wall in all the directions except the direction in which the air flows out. The disk apparatus disclosed in this prior art is constructed such that the slider is caused to fly by the balance between the negative pressure generated by the negative pressure cavity, the head load, and the positive pressure. According to this construction, the positive pressure decreases under a reduced pressure environment, but the negative pressure also decreases simultaneously. It follows that it is possible to realize a slider low in the decrease of the flying amount.

As described above, it is possible to control the flying amount of the slider, the flying posture of the slider, and the decrease in the flying amount of the slider under a reduced pressure by designing appropriately the irregular shape of the disk-facing surface of the slider. The irregular shape of the disk-facing surface of the slider is defined by grooves having a single kind or two kinds of depths in view of the manufacturing cost of the slider.

In recent years, the slider is being made smaller and smaller. The size of the slider is standardized in accordance with IDEMA (International Disk Drive Equipment and Materials Association). In accordance with the size, the slider is termed a mini slider (100% slider), a micro slider (70% slider), a nano slider (50% slider), a pico slider (30% slider) and a femto slider (20% slider). Since the magnetic head is collectively manufactured by a thin film process, the slider with a smaller size makes it possible to realize a larger magnetic head quantity with the same area of wafer and, thus, the manufacturing cost can be reduced. The miniaturization of the slider permits improving the capability for the magnetic head to follow the irregularity on the surface of the magnetic disk. Further, the mass at the distal end portion of the head actuator is decreased and, thus, the seeking speed can be increased.

However, if the area of the disk-facing surface of the slider is decreased in accordance with miniaturization of the slider, the problems pointed out below are emerge.

1) The flying force of the magnetic head is decreased, which causes the slider to be incapable of supporting the head load. As a result, the magnetic head is brought into contact with the surface of the magnetic disk.

2) If the slider is incapable of supporting the head load, the flying state of the magnetic head is lost.

In order to overcome the problems pointed out above, it was customary in the past to diminish the head load in accordance with miniaturization of the slider. Even where the slider is miniaturized from the pico slider into the femto slider, the decrease in the head load is the mainstream measure that is taken in recent years. For example, where the femto slider is used in the 2.5 inch type hard disk drive for the mobile apparatus, the upper limit of the head load is said to be 19.6 mN (2 gf).

However, if the head load is diminished in accordance with miniaturization of the slider, the suspension and the slider tend to jump up from the magnetic disk when an impact is applied to the disk apparatus. When the jumping up slider is brought back, it is possible for the slider to collide with the magnetic disk so as to do damage to the recorded data. It follows that the decrease of the head load deteriorates the resistance to the impact of the disk apparatus.

Also, if the mass of the slider is decreased in accordance with miniaturization of the slider, it may be possible to improve the resistance to the impact of the slider. However, the jumping force of slider when an impact is applied to the slider is greatly affected by the equivalent mass of the suspension. Such being the situation, the decrease in the mass of the slider scarcely contributes in practice to the improvement in the resistance to the impact of the slider. It follows that it is possible for the decrease of the head load in accordance with miniaturization of the slider to provide a factor for decreasing the resistance to the impact of the slider and for lowering the reliability of the disk apparatus.

### BRIEF SUMMARY OF THE INVENTION

According to an aspect of the present invention, there is provided a disk apparatus, comprising a disk-shaped recording medium; a driving section configured to support and rotate the recording medium; a head including a slider having a disk-facing surface positioned to face a surface of the recording medium and configured to fly by an air stream generated by the rotation of the recording medium between the surface of the recording medium and the disk-facing surface of the slider, and a head portion mounted on the slider configured to perform recording/reproduction of information in and out of the recording medium; and a head suspension supporting the head to be movable relative to the recording medium and applying a head load to the head, the head load being directed toward the surface of the recording medium. The disk-facing surface of the slider is sized not larger than 0.935 (mm)×0.77 (mm), and the head load L (mN) and the lowest linear velocity A (m/s) of the recording medium have the following relationship: L≧2.74×A+2.7.

According to another aspect of the present invention, there is provided a head suspension assembly used in a disk apparatus including a disk-like recording medium, and a driving section configured to support and rotate the recording medium, comprising: a head including a slider having a disk-facing surface positioned to face the surface of the recording medium and configured to fly by an air stream generated by the rotation of the recording medium between the surface of the recording medium and the disk-facing surface of the slider, and a head section mounted on the slider configured to perform the recording/reproduction of information in and out of the recording medium; and a head suspension supporting the head to be movable relative to the recording medium and applying a head load to the head, the head load being directed toward the recording medium. The disk-facing surface of the slider is sized not larger than 0.935 (mm)×0.77 (mm), and the head load L (mN) and the lowest linear velocity A (m/s) of the recording medium have the following relationship: L≧2.74×A+2.7.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of the present invention.

FIG. 1 is a plan view showing an HDD according to one embodiment of the present invention;

FIG. 2 is a side view showing in a magnified fashion the magnetic head portion included in the HDD shown in FIG. 1;

FIG. 3 is a perspective view showing a slider on the side of a disk-facing surface, the slider being included in the magnetic head;

FIG. 4 is a plan view showing the disk-facing surface of the slider;

FIG. 5 schematically shows the continuous type pad and the separation type pad for each aspect ratio in the disk-facing surface of the slider;

FIG. 6 is a graph showing the relationship between the aspect ratio and the generated force for each of the slider provided with the continuous type pad and the slider provided with the separation type pad;

FIG. 7 is a side view showing the construction of the slider;

FIG. 8 is a graph showing the relationship between the linear velocity of the disk and the generated force; and

FIG. 9 is a graph showing the relationship between the lowest linear velocity in the apparatus and the head load in the case of using a pico slider.

### DETAILED DESCRIPTION OF THE INVENTION

An embodiment of the present invention, in which a disk apparatus of the present invention is applied to a hard disk drive (hereinafter, referred to HDD), will now be described in detail with reference to the accompanying drawings.

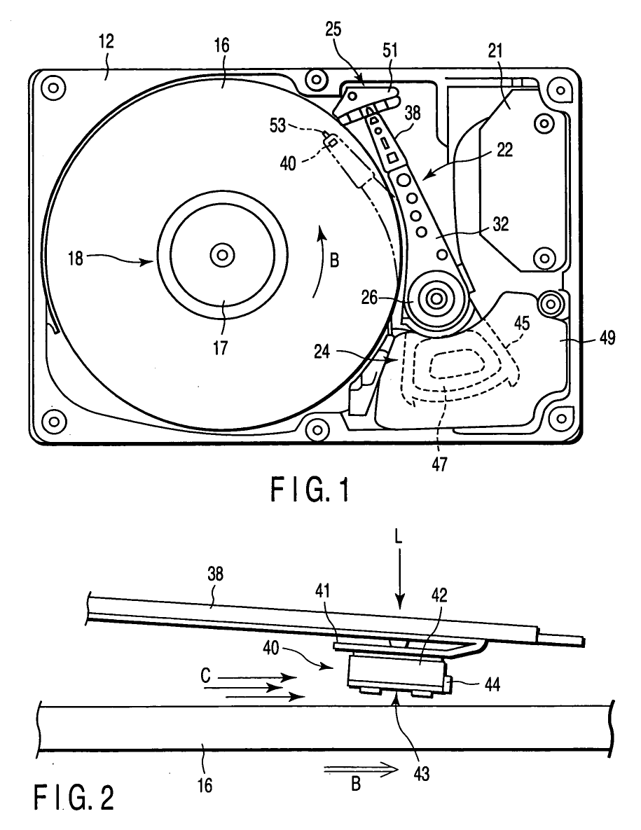

As shown in FIG. 1, the HDD comprises a rectangular box-like case 12 open in the top, and a top cover (not shown) screwed to the case 12 with a plurality of screws so as to close the opened top of the case 12.

Housed in the case 12 are, for example, two magnetic disks 16 (one magnetic disk 16 alone being shown in the drawing) used as a recording medium, a spindle motor 18 used as a driving section for supporting and rotating the magnetic disk, a plurality of magnetic heads for writing in and reading information from the magnetic disk, a carriage assembly 22 supporting the magnetic heads to be movable relative to the magnetic disks 16, a voice coil motor (hereinafter, referred to VCM) 24 for rotating the carriage assembly 22 and determining the position of the carriage assembly 22, a ramp load mechanism 25 for holding the magnetic heads at a retreat position apart from the magnetic disks when the magnetic heads are moved to the outermost circumferential surface of the magnetic disk, and a substrate unit 21 having, for example, a head IC.

A printed circuit board (not shown) is screwed to the outer surface of the bottom wall of the case 12. The printed circuit board controls the operation of the spindle motor 18, the VCM 24, and the magnetic heads via the substrate unit 21.

Each of the magnetic disks 16 has a magnetic recording layer on each of the upper surface and the lower surface thereof. The two magnetic disks 16 are fitted to outer circumferential surface of a hub (not shown) of the spindle motor 18 and fixed on the hub by a clamp spring 17. As a result, the two magnetic disks 16 are coaxially stacked on the hub with a prescribed gap therebetween. If the spindle motor 18 is driven, the two magnetic disks 16 are rotated in a direction denoted by an arrow B at a prescribed speed, e.g., at a speed of 4200 rpm.

The carriage assembly 22 includes a bearing section 26 fixed to the bottom wall of the case 12 and a plurality of arms 32 extending from the bearing section 26. These arms 32, which are positioned in parallel to the surfaces of the magnetic disks 16 and a prescribed distance apart from each other, extend in the same direction from the bearing section 26. The carriage assembly 22 also includes elastically deformable elongate plate-like suspensions 38. Each suspension 38 is formed of a leaf spring. The proximal end of the suspension 38 is fixed to the tip of the arm 32 by means of a spot welding or adhesion, and the suspension 38 extends from the arm 32. Incidentally, it is possible for each suspension 38 to be formed integral with the corresponding arm 32. The arm 32 and the suspension 38 collectively form a head suspension. Also, the head suspension and the magnetic head collectively form a head suspension assembly.

As shown in FIG. 2, each magnetic head 40 includes a substantially rectangular slider 42 and a head portion 44 for recording/reproduction of information, which is mounted to the end surface of the slider 42. The slider 42 is fixed to a gimbal spring 41, which is mounted on the distal end portion of the suspension 38. A head load L directed toward the surface of the magnetic disk 16 is applied to each of the magnetic heads 40 by the elasticity of the suspension 38.

As shown in FIG. 1, the carriage assembly 22 includes a supporting frame 45 extending from the bearing section 26 in a direction opposite to the extending direction of the arm 32. A voice coil 47 constituting a part of the VCM is provided on the supporting frame 45. The supporting frame 45, which is made of a synthetic resin, is formed integral with the voice coil 47 in a manner to surround the outer circumferential surface of the voice coil 47. The voice coil 47 is located between a pair of yokes 49 fixed on the case 12. These yokes 49 and a magnet (not shown) fixed to one of these yokes collectively form the VCM 24. When an electric power is supplied to the voice coil 47, the carriage assembly 22 rotates about the bearing section 26 and moves the magnetic head 40 to a desired track on the magnetic disk 16.

The ramp load mechanism 25 includes a ramp 51 mounted on the bottom wall of the case 12 and arranged outside the magnetic disk 16, and a tab 53 extending from the distal end of each of the suspensions 38. When the carriage assembly 22 is rotated to reach the retreat position outside the magnetic disk 16, each tab 53 is engaged with the ramp surface formed on the ramp 51 and, then, is pulled upward along the inclined ramp surface so as to unload the magnetic head from the magnetic disk.

The construction of the magnetic head 40 will now be described in detail. As shown in FIGS. 2 to 4, the magnetic head 40 includes a slider 42 having a shape of substantially rectangular-prism. The slider 42 has a disk-facing surface 43 positioned to face the surface of the magnetic disk 16. The slider 42 is formed as a flying type slider and is caused to fly by an air stream C generated between the disk surface and the disk-facing surface 43 of the slider 42 in accordance with rotation of the magnetic disk 16. During operation of the HDD, the disk-facing surface 43 of the slider 42 is positioned to face the disk surface with a prescribed clearance defined therebetween. The direction of the air stream C is equal to the rotating direction B of the magnetic disk 16. The head portion 44 of the magnetic head 40 is formed on the end surface of the slider 42 on the downstream side of the air stream C. The slider 42 is caused to fly in such an inclined posture that the head portion 44 is positioned closest to the disk surface. Incidentally, the head portion 44 includes a recording element (not shown) and a reproducing element (not shown) for recording/reproducing information in and out of the magnetic disk 16.

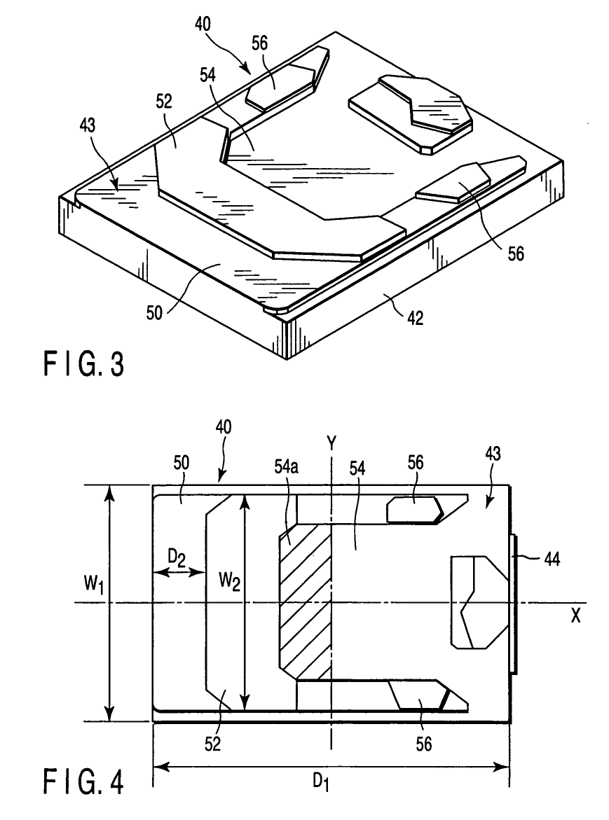

As shown in FIGS. 3 and 4, the disk-facing surface 43 of the slider 42 is formed substantially rectangular and has a first axis X and a second axis Y perpendicular to the first axis X. The slider 42 is arranged to face the surface of the magnetic disk 16 such that, during the operation of the HDD, the first axis X is substantially equal to the direction of the air stream C. The slider 42 is formed as a femto slider. Concerning the size of the disk-facing surface 43, the length D1 in the direction of the first axis X is 0.935 mm or less, and the width W1 in the direction of the second axis Y is 0.77 mm or less. In general, the disk-facing surface 43 is sized at D1: 0.85 mm×W1: 0.7 mm.

A stepped surface 50 is formed on the disk-facing surface 43. The stepped surface 50 is formed in substantially a U-shape such that the upstream side is closed and the downstream side is left open with respect to the flowing direction of the air stream C. In order to maintain the pitch angle of the magnetic head 40, a leading pad 52 for allowing the slider 42 to be supported by the air film is formed on the stepped surface 50. The leading pad 52 has an elongate shape, continuously extends in the direction of the second axis Y, and is positioned in the portion on the in-flow side of the slider 42 relative to the air stream C.

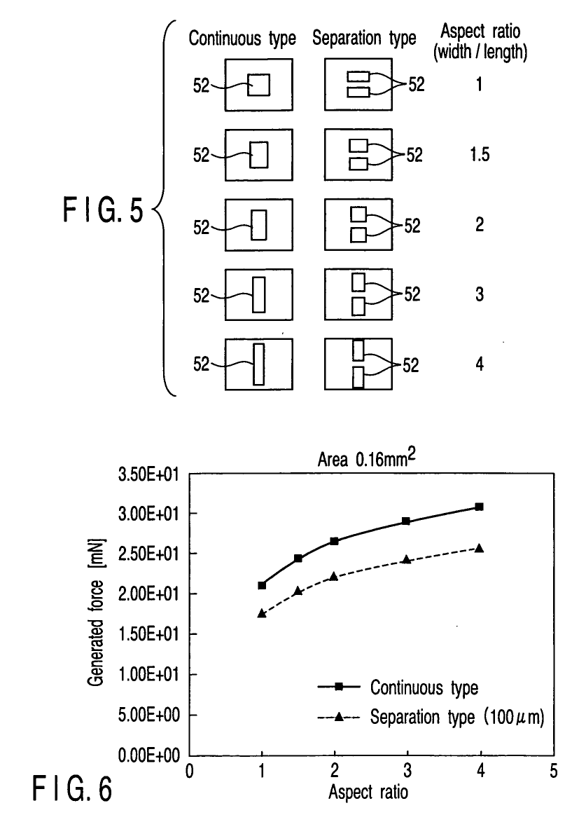

The flying force generated in the slider 42 was comparatively analyzed as follows, covering the case where the leading pad 52 is formed in a manner to extend continuously in the direction of the second axis Y and the case where the leading pad 52 is separated into two sections in the direction of the second axis Y. As shown in FIG. 5, a leading pad having a prescribed area was formed on the disk-facing surface of the slider 42, and the flying force was compared by changing the aspect ratio (ratio of the length to the width) of the pad to fall within a range of between 1 and 4.

FIG. 6 is a graph showing the simulation results. As shown in FIG. 6, the flying force generated by the continuous type pad was greater than the flying force generated by the separation type pad in the case where the aspect ratio was 2 or more. The experimental data clearly supports that the flying force can be generated more efficiently by allowing the pad to be shaped continuous in the direction perpendicular to the flowing direction of the air stream C. In other words, it is clearly supported that the pad of the particular shape is effective for compensating for the decrease of the flying force accompanying the miniaturization of the disk-facing surface of the slider 42 and for maintaining the flying posture of the slider 42.

It is desirable for the width W2 of the leading pad 52 in the direction of the second axis Y to be larger than 60% of the width D2 of the disk-facing surface 43 of the slider 42. In this embodiment, the width W2 is set at about 60% of the width W1. In order to allow the leading pad 52 to have a rigidity of the air film efficiently, it is desirable to form the stepped surface 50 on the upstream side of the leading pad 52 in the flowing direction of the air stream C. Such being the situation, the stepped surface 50 was formed on the upstream side of the leading pad 52, and the length D2 of the-stepped surface in the direction of the first axis X was set at 10% or more of the length D1 of the disk-facing surface 43.

The leading pad 52 has the smallest width portion in the direction of the first axis X, and the leading pad 52 is left open from the smallest width portion toward the downstream side of the disk-facing surface 43 in the flowing direction of the air stream C. The stepping effect can be expected from the particular construction, and the particular construction is effective for supporting a large head load L with a smaller area.

As shown in FIGS. 3 and 4, a negative pressure cavity 54 defined by a recess is formed in the central portion of the disk-facing surface of the slider 42. The negative pressure cavity 54 is positioned on the downstream side of the leading pad 52 in the flowing direction of the air stream C and is left open toward the end on the downstream side of the disk-facing surface 43 of the slider 42.

As described above, the negative pressure cavity 54 is formed to include a pressure reducing portion generated on the downstream side of the leading pad 52, thereby realizing a negative pressure cavity generating a large negative pressure. By forming the negative pressure cavity 54 defined by a recess, it is possible to generate a negative pressure in the central portion of the disk-facing surface 43 of the slider 42 in all the skew angles realized in the HDD. It follows that it is possible to maintain constant the rolling angle of the slider 42 in the position in any radial direction of the magnetic disk 16.

On the other hand, if the negative pressure generated at the end on the inflow side of the slider 42 is excessively high, it is difficult to maintain the pitch angle, with the result that the flying posture of the magnetic head 40 is lost. Such being the situation, an area 54a occupied by the negative pressure cavity 54 in a half region on the upstream side of the disk-facing surface 43 of the slider 42 in the direction of the first axis X is set at 25% or less of the half area of the disk-facing surface 43 of the slider 42.

As shown in FIGS. 3 and 4, two independent side pads 56 may be formed on the stepped surface 50. These side pads 56 are positioned on the downstream side of the leading pad 52 in the flowing direction of the air stream C and arranged on both sides of the negative pressure cavity 54 with respect to the direction of the second axis Y. By forming the side pads 56, it is possible to generate a positive pressure on both sides of the negative pressure cavity 54 in the direction of the second axis Y. The positive pressure thus generated corresponds to the negative pressure generated in the central portion of the disk-facing surface 43 of the slider 42. As a result, the moment of the magnetic head 40 in the rolling direction can be suppressed. It follows that it is possible to suppress the rolling of the magnetic head 40 and to maintain the desired flying posture of the magnetic head 40.

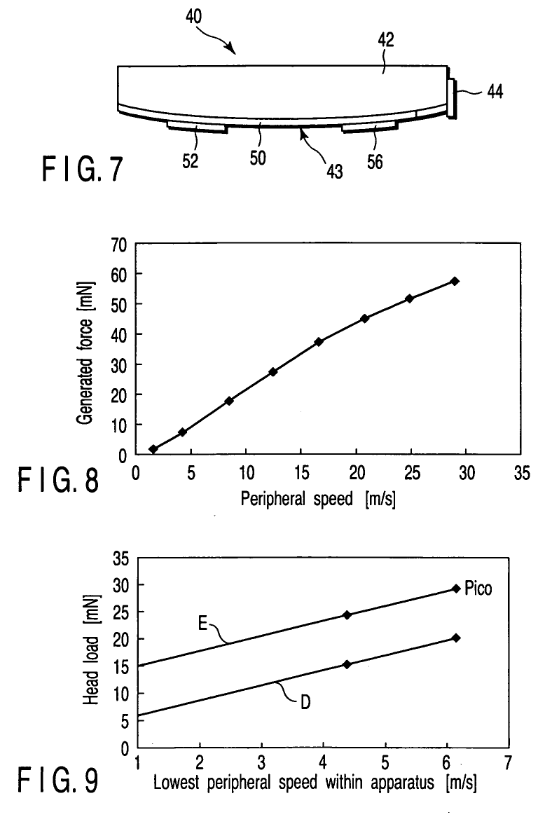

As shown in FIG. 7, the disk-facing surface 43 of the slider 42 may be formed in an arcuate surface such that the central portion of the disk-facing surface 43 protrudes toward the surface of the magnetic disk and that the maximum protruding height in the direction of the first axis X is not smaller than 10 nm. If the disk-facing surface 43 of the slider 42 is shaped arcuate, it is possible to shorten the distance between the side pad 56 and the surface of the magnetic disk so as to increase the rigidity of the air film generated at the side pad 56. Even where the side pad 56 is not provided, it is possible to diminish the flying amount of the slider relative to the pitch angle so as to make it possible to generate a positive pressure and a negative pressure.

In the magnetic head 40 described above, the disk-facing surface 43 of the slider 42 is obtained by forming first the surface of the slider 42 in an arcuate surface having the curvature described above, followed by etching the arcuate surface so as to obtain the recess, the stepped surface 50, the leading pad 52, the side pads 56, etc.

In the HDD having a diameter of 2.5 inches, which is used nowadays, the recording area formed in a radial position of 14 mm to 30 mm of the magnetic disk is used under a rotational speed of 4200 rpm, and a head load of 29.6 mN (3 gf) is applied to the pico slider. In the HDD having a diameter of 1.8 inches, which is used nowadays, the recording area formed in a radial position of 10 mm to 22 mm of the magnetic disk is used under a rotational speed of 4200 rpm, and a head load of 24.5 mN (2.5 gf) is applied to the pico slider.

The force, for supporting the head load, generated from the rigidity of the air film is dependent on the peripheral speed of the magnetic disk. If the peripheral speed is low, it is impossible to support a large head load. The force generated by the rigidity of the air film, which is generated in the slider of the magnetic head, is substantially proportional to the peripheral speed, as shown in FIG. 8. Therefore, in the prior art, the head load is lowered, if the peripheral speed of the magnetic disk is lowered in accordance with decrease in the diameter of the magnetic disk.

In the embodiment of the present invention, the head load L is not decreased from the head load at the use of the pico slider, but is increased in spite of the employment of the femto slider. The relationship between the head load L (mN) of the pico slider and the lowest linear velocity A (m/s) within the HDD can be represented by formula (1) given below:

L (mN)=2.74×A (m/s)+12.5 (1)

The inclination in formula (1) represents the ratio of the head load that can be supported because of the increase of the linear velocity. To be more specific, in 4200 rpm-2.5 inches HDD, the lowest linear velocity of the disk is 6.15 (m/s), since the inner track radius of 2.5 inches HDD is 14 (mm). In 4200 rpm-1.8 inches HDD, the lowest linear velocity of the disk is 4.40 (m/s), since the inner track radius of 1.8 inches HDD is 10 (mm).

In the disk drives having magnetic disks with a diameter of 2.5 inches and 1.8 inches, respectively, head loads of 3 gf (29.4 mN) and 2.5 gf (24.5 mN) are applied to the slider, respectively. If the points of these lowest linear velocity and the head load are plotted on a graph, obtained is a straight line E as shown in FIG. 9. The inclination of the straight line E is 2.74. The straight line E indicates the relationship between the lowest linear velocity within the HDD and an opportune head Pico slider. Formula (1) given above can be obtained from these values.

Also, in the case of using a femto slider in the HDD having a magnetic disk with a diameter of 2.5 inches, a straight line D can be obtained from the inclination of the straight line E, as shown in FIG. 9. The straight line D is given by parallel transferring line E to coincide the point which shows the lowest linear velocity within the i2.5 inches HDD. It follows that the relationship between the head load L of 19.6 mN (2 gf) and the lowest linear velocity A (m/s) can be represented by formula (2) given below:

L (mN)=2.74×A (m/s)+2.7 (2)

In the present embodiment, a femto slider is used as the slider 42, and the suspension 38 causes a head load L (mN) given below to be applied to the magnetic head 40:

L (mN)≧2.74×A (m/s)+2.7

where A represents the lowest linear velocity within the HDD.

Where the height of the stepped surface 50 of the slider 42 was set at 115 nm, the height of the negative pressure cavity surface was set at 1.1 μm, and the head load L at the inner circumference of the magnetic disk 16 at a radial position of 14 mm was set at 29.4 mN (3 gf) in the HDD of the construction described above, the magnetic head 40 was analyzed to fly in a flying amount of 14.8 nm and at a pitch angle of 130 (urad). Also, where the atmospheric pressure was 0.7 atm at the heights of 3,000 m, the flying amount was analyzed to be 11.1 nm.

According to the HDD and the head suspension assembly of the construction described above, it is possible to achieve a sufficiently large flying amount of the magnetic head without decreasing the head load even in the case of using a slider including the disk-facing surface having an area not larger than 0.935 mm×0.77 mm. Such being the situation, it is possible to miniaturize the magnetic head so as to improve the recording density. It is also possible to improve the impact resistance of the magnetic head. Thus, there can be obtained at a low cost an HDD and a head suspension assembly excellent in the impact resistance and capable of achieving the recording/reproduction at a high accuracy.

Additional advantages and modifications will readily occur to those skilled in the art. Therefore, the present invention in its broader aspects is not limited to the specific details and representative embodiments shown and described herein. Accordingly, various modifications may be made without departing from the spirit or scope of the general inventive concept as defined by the appended claims and their equivalents. For example, the number of magnetic disks included in the HDD is not limited to 2 and can be increased or decreased as desired.

What is claimed is:

1. A disk apparatus, comprising:
a disk-shaped recording medium;
a driving section configured to support and rotate the recording medium;
a head including a slider having a disk-facing surface positioned to face a surface of the recording medium and configured to fly by an air stream generated by the rotation of the recording medium between the surface of the recording medium and the disk-facing surface of the slider, and a head portion mounted on the slider and configured to perform recording/reproduction of information in and out of the recording medium; and
a head suspension supporting the head to be movable relative to the recording medium and applying a head load to the head, the head load being directed toward the surface of the recording medium, the disk-facing surface of the slider being sized not larger than 0.935 (mm)×0.77 (mm), and the head load L (mN) and the lowest linear velocity A (m/s) of the recording medium having the following relationship:
L≧2.74×A+2.7.

2. The disk apparatus according to claim 1, wherein the disk-facing surface of the slider has a first axis extending in a flowing direction of the air stream, and a second axis perpendicular to the first axis;
the slider includes a negative pressure cavity configured to generate a negative pressure, defined by a recess formed in the central portion of the disk-facing surface, and a leading pad formed on the disk-facing surface and positioned on the upstream side of the negative pressure cavity in the flowing direction of the air stream; and
the leading pad continuously extends in the direction of the second axis, the width of the leading pad in the direction of the second axis being not smaller than 60% of the width of the disk-facing surface in the direction of the second axis.

3. The disk apparatus according to claim 2, wherein the leading pad has the smallest width portion in the direction of the first axis and is shaped open from the smallest width portion toward the downstream side of the disk-facing surface in the flowing direction of the air stream.

4. The disk apparatus according to claim 2, wherein the area occupied by the negative pressure cavity in the half region of the disk-facing surface positioned on the upstream side of the air stream in the direction of the first axis is not larger than 25% of half the area of the disk-facing surface.

5. The disk apparatus according to claim 2, wherein the slider includes a plurality of independent side pads formed on the disk-facing surface, the side pads being formed on the downstream side of the leading pad in the flowing direction of the air stream and positioned on both sides of the negative pressure cavity in the direction of the second axis.

6. The disk apparatus according to claim 1, wherein the disk-facing surface of the slider is shaped arcuate such that the central portion of the disk-facing surface protrudes toward the surface of the recording medium and that the maximum protruding height in the direction of the first axis is not smaller than 10 nm.

7. A head suspension assembly used in a disk apparatus including a disk-shaped recording medium, and a driving section for supporting and rotating the recording medium, comprising:
a head including a slider having a disk-facing surface positioned to face the surface of the recording medium and configured to fly by an air stream generated by the rotation of the recording medium between the surface of the recording medium and the disk-facing surface of the slider, and a head section mounted on the slider configured to perform the recording/reproduction of information in and out of the recording medium; and
a head suspension supporting the head to be movable relative to the recording medium and applying a head load to the head, the head load being directed toward the recording medium,
the disk-facing surface of the slider being sized not larger than 0.935 (mm)×0.77 (mm), and the head load L (mN) and the lowest linear velocity A (m/s) of the recording medium having the following relationship:
L≧2.74×A+2.7.

8. The head suspension assembly according to claim 7, wherein the disk-facing surface of the slider has a first axis extending in a flowing direction of the air stream, and a second axis perpendicular to the first axis;
the slider includes a negative pressure cavity configured to generate a negative pressure, defined by a recess formed in the central portion of the disk-facing surface, and a leading pad formed on the disk-facing surface and positioned on the upstream side of the negative pressure cavity in the flowing direction of the air stream; and
the leading pad continuously extends in the direction of the second axis, the width of the leading pad in the direction of the second axis being not smaller than 60% of the width of the disk-facing surface in the direction of the second axis.

9. The head suspension assembly according to claim 8, wherein the leading pad has the smallest width portion in the direction of the first axis and is shaped open from the smallest width portion toward the downstream side of the disk-facing surface in the flowing direction of the air stream.

10. The head suspension assembly according to claim 8, wherein the area occupied by the negative pressure cavity in the half region of the disk-facing surface positioned on the upstream side of the air stream in the direction of the first axis is not larger than 25% of half the area of the disk-facing surface.

11. The head suspension assembly according to claim 8, wherein the slider includes a plurality of independent side pads formed on the disk-facing surface, the side pads being formed on the downstream side of the leading pad in the flowing direction of the air stream and positioned on both sides of the negative pressure cavity in the direction of the second axis.

12. The head suspension assembly according to claim 7, wherein the disk-facing surface of the slider is shaped arcuate such that the central portion of the disk-facing surface protrudes toward the surface of the recording medium and that the maximum protruding height in the direction of the first axis is not smaller than 10 nm.
